(19) United States
(12) Patent Application Publication
(10) Pub. No.: US 2026/0146463 A1
(43) Pub. Date: May 28, 2026

(54) BATTERIES OF DIFFERENT CAPACITIES

(71) Applicant: Maytronics Ltd., Kibutz Yizrael (IL)

(72) Inventors: Shay Witelson, Kibbutz Yizrael (IL); Boaz Ben Dov, Ram On (IL)

(73) Assignee: Maytronics Ltd., Kibutz Yizrael (IL)

(21) Appl. No.: 19/399,569

(22) Filed: Nov. 24, 2025

Related U.S. Application Data
(63) Continuation of application No. 18/550,126.
(60) Provisional application No. 63/158,754, filed on Mar. 9, 2021.

(51) Int. Cl. E04H 4/16; H02J 50/10

(52) U.S. Cl. CPC E04H 4/1654; H02J 50/10

(57) ABSTRACT

A pool cleaning robot that may include a housing; a power supply cable interface for interfacing with a power supply cable; wherein at least a part of the power supply cable is external to the housing; a power supply control unit, and a wireless charging interface. The power supply control unit may be configured to control (a) a provision of power from the power supply cable to the wireless charging interface; and (b) a provision of power from the wireless charging interface to one or more power consuming elements of the pool cleaning robot

### CROSS REFERENCE

This application claims priority from U.S. provisional patent Ser. No. ______ filing date Mar. 9, 2021 which is incorporated herein in its entirety.

### BACKGROUND OF THE INVENTION

Pool Cleaning Robots (“PCRs”) are adapted for use for cleaning a pool while being connected to electrical power cables or to a hose of a suction system. The hose and/or a long power cable or cord are costly, bulky, can get entangled and may temporarily limit the usage of the pool.

There is a growing and continuing need to provide systems and methods for battery powered self-propelled pool cleaning robots and/or solar powered PCR or solar powered system to charge rechargeable batteries for pool cleaning systems.

There is a growing need to provide robotic pool cleaning systems that are easily and conveniently adaptable to changing end user flexibility needs or requirements. Namely, the modularity and interchangeability of the pool cleaning system components, that may include the PCR, are becoming increasingly important to end users who need continuity of PCR use at all times.

### SUMMARY OF THE INVENTION

There may be provided a pool cleaning system that may include photovoltaic solar cells (a solar panel) on-board a floating unit that floats at the pool waterline; and that may charge a battery on-board the floating unit that is electrically wired to a PCR that is submerged also capable of underwater cleaning and may also perform waterline or above waterline cleaning or to charge batteries that are on-board a PCR or to charge batteries that belong to a PCR or to a pool cleaning system when both these terms may each or both refer to the same subject-matter.

Also provided are components that are an object of this invention, that may be modularly removed, replaced or added to the PCR or pool cleaning system that may modify the way that the PCR or the pool cleaning system operates and functions, More detailed descriptions are given below.

### BRIEF DESCRIPTION OF THE DRAWINGS

To understand the invention and to see how it may be carried out in practice, embodiments and/or arrangements will now be described, by way of a non-limiting examples only, with reference to the accompanying drawings, in which:

FIG. 1 depicts a top view of an example of a floating unit of a pool cleaning system;

FIG. 2 depicts a bottom view of an example of a floating unit of a pool cleaning system;

FIG. 3 depicts a side view of an example of a floating unit of a pool cleaning system;

FIG. 4 depicts an exploded view of an example of floating unit of a pool cleaning system;

FIG. 5. depicts a top view of an example of floating unit of a pool cleaning system;

FIG. 6. depicts a bottom view of an example of floating unit of a pool cleaning system;

FIG. 7. depicts an example of a wireless electrical power connection;

FIG. 8. depicts a top view of an example of a system;

FIG. 9. depicts a top view of an example of a floating unit solar panels;

FIG. 10. depicts a top view of an example of a floating unit solar panels;

FIG. 11. depicts a top view of an example of a floating unit solar panels;

FIG. 12. depicts an example of a system;

FIG. 13. depicts an example of a system;

FIG. 14. depicts an example of a system;

FIG. 15. depicts an example of a floating unit caddy;

FIG. 16. depicts an example of a PCR with rechargeable battery attached onto the housing;

FIG. 17 depicts an example of a PCR with rechargeable battery attached onto the housing;

FIG. 18 depicts an example of a PCR with rechargeable battery being charged;

FIG. 19 depicts an example of a PCR and a floating unit;

FIG. 20 is an example of a part of a PCR;

FIG. 21 is an example of a method;

FIG. 22 is an example of a method; and

FIG. 23 is an example of a method.

### DETAILED DESCRIPTION OF EMBODIMENTS

Any reference to a pool cleaner or pool cleaning robot or PCR should be applied, mutatis mutandis to a method that is executed by a pool cleaner and/or to a non-transitory computer readable medium that stores instructions that once executed by the pool cleaner will cause the pool cleaner to execute the method.

Any reference to method should be applied, mutatis mutandis to a pool cleaner or pool cleaning robot or PCR that is configured to execute the method and/or to a non-transitory computer readable medium that stores instructions that once executed by the pool cleaner will cause the pool cleaner to execute the method.

Any reference to a non-transitory computer readable medium should be applied, mutatis mutandis to a method that is executed by a pool cleaner or pool cleaning robot or PCR and/or a pool cleaner that is configured to execute the instructions stored in the non-transitory computer readable medium.

The term “and/or” is additionally or alternatively.

“Swimming pool” or “pool” mean any spa or tank or any reservoir containing liquid.

Because the apparatus implementing the present invention is, for the most part, composed of optical components, sensors and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

In the following specification, the invention will be described with reference to specific examples of embodiments of the invention. It will, however, be evident that various modifications and changes may be made therein without departing from the broader spirit and scope of the invention as set forth in the appended claims.

The word “may include” does not exclude the presence of other elements or steps then those listed in a claim. It is understood that the terms so used are interchangeable under appropriate circumstances such that the embodiments of the invention described herein are, for example, capable of operation in other orientations than those illustrated or otherwise described herein.

There may be provided a system that may include a pool cleaning robot; a power supply cable; a power supplier. The pool cleaning robot may include a housing, a power supply cable interface for interfacing with the power supply cable; a power supply control unit, and a wireless charging interface. The wherein the power supply control unit may be configured to control (a) a provision of power from the power supply cable to the wireless charging interface; and (b) a provision of power from the wireless charging interface to one or more power consuming elements of the pool cleaning robot.

There may be provided a pool cleaning robot that may include a housing; a power supply cable interface for interfacing with a power supply cable; wherein at least a part of the power supply cable may be external to the housing; a power supply control unit, and a wireless charging interface. The power supply control unit may be configured to control (a) a provision of power from the power supply cable to the wireless charging interface; and (b) a provision of power from the wireless charging interface to one or more power consuming elements of the pool cleaning robot.

The wireless charging interface may be configured to wirelessly charge a rechargeable battery via a battery wireless charging interface when receiving the power from the power supply cable.

The wireless charging interface may be further configured to provide power from the rechargeable battery; and wherein the power supply control unit may be configured to control a provision of the power from the detachable rechargeable battery to the one or more power consuming elements of the pool cleaning robot.

The pool cleaning robot may include the rechargeable battery.

The rechargeable battery may include an additional battery wireless charging interface.

The additional battery wireless charging interface may be facing away from the pool cleaning robot.

The rechargeable battery may be a detachable rechargeable battery.

The rechargeable battery may be a non-detachable rechargeable battery.

The power from the power supply cable may be provided by a floating unit.

The power from the power supply cable may be provided by an external power supply.

The power supplier may be a floating unit.

The power supplier may be a floating unit equipped with a one or more solar panels.

The power supplier may be a floating unit equipped with a one or more solar panels and a bypass wireless charging unit for receiving power from an external power supply unit.

The power supplier may be an external power supply unit.

The external power supply unit may be also configured to charge one or more rechargeable batteries.

There may be provided a system that may include a pool cleaning robot; at least one power supply cable; and power suppliers. The pool cleaning robot may include a housing, a rechargeable battery and at least one wireless charging interface. The pool cleaning robot may be configured to wirelessly receive power from each power supplier of the power suppliers, via one of the at least one power supply cable and via a wireless charging interface of the at least one wireless charging interface. The power suppliers may include a floating unit and an external power supply unit.

The at least one power supply cable may include a first power supply cable and a second power supply cable; wherein a first end of the first power supply cable may be electrically coupled to the external power supply unit and a first end of the second power supply unit may be coupled to the floating unit.

There may be provided a system that may include a pool cleaning robot; a floating unit that may include a solar panel; and a power supply cable. The pool cleaning robot may include a housing, a detachable rechargeable battery and a wireless charging interface. The pool cleaning robot may be configured to wirelessly receive power from the floating unit via the power supply cable.

The floating unit may include a floating unit battery that may be configured to be charged from the solar panel.

The floating unit may include a bypass wireless charging unit for receiving power from an external power supply unit.

There is provided a PCR and/or a system that may include a floating unit (or “float”) and a cable (power supply cable) tethering to the PCR.

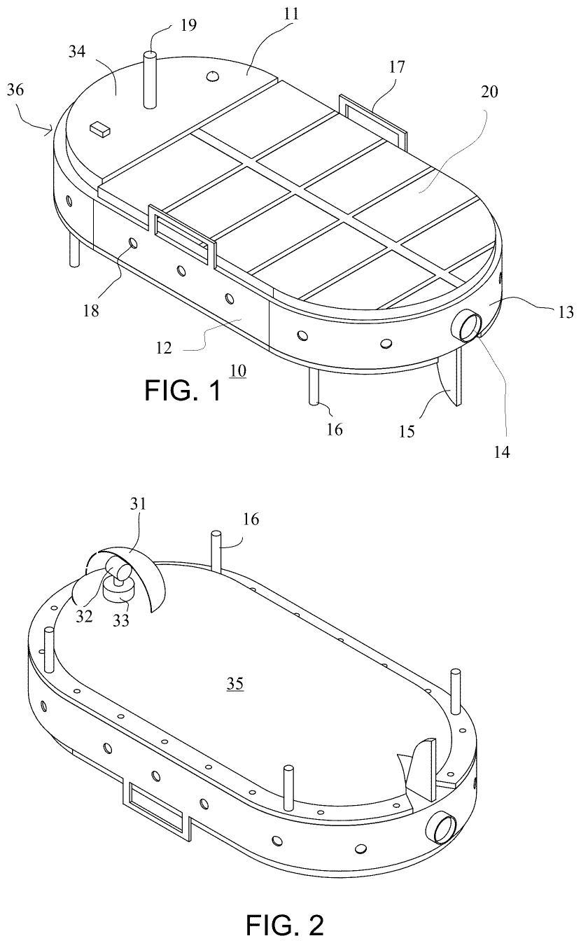

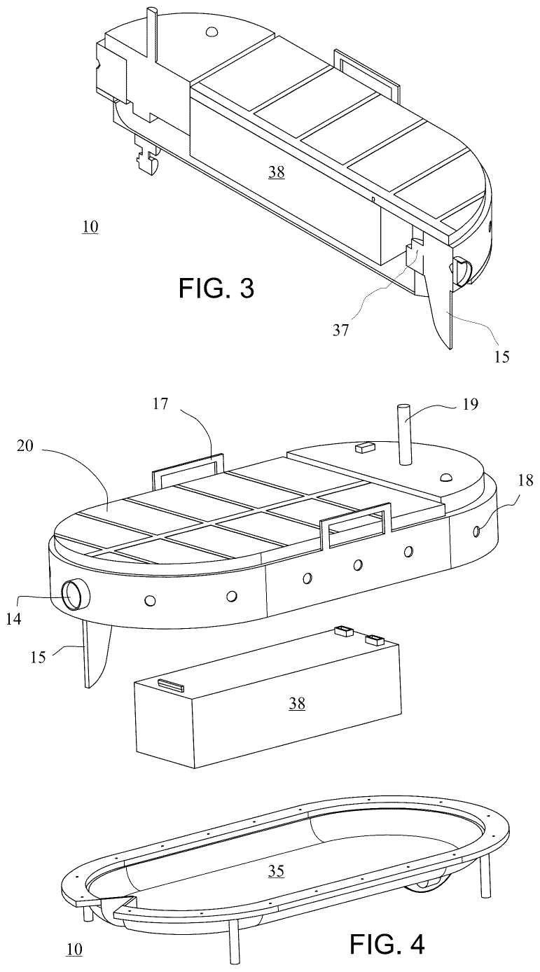

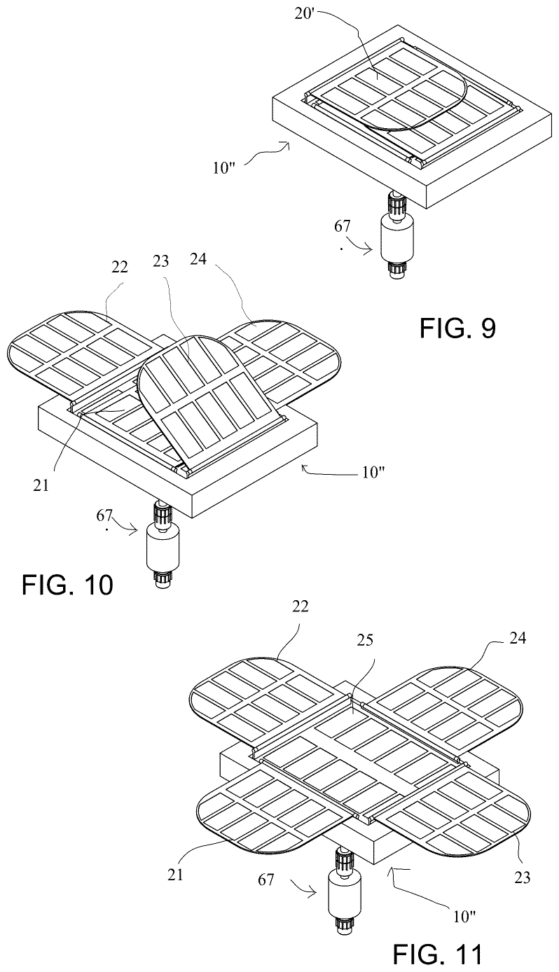

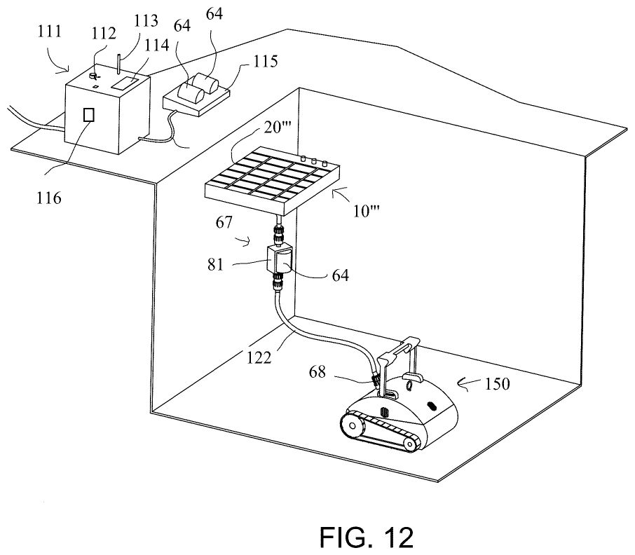

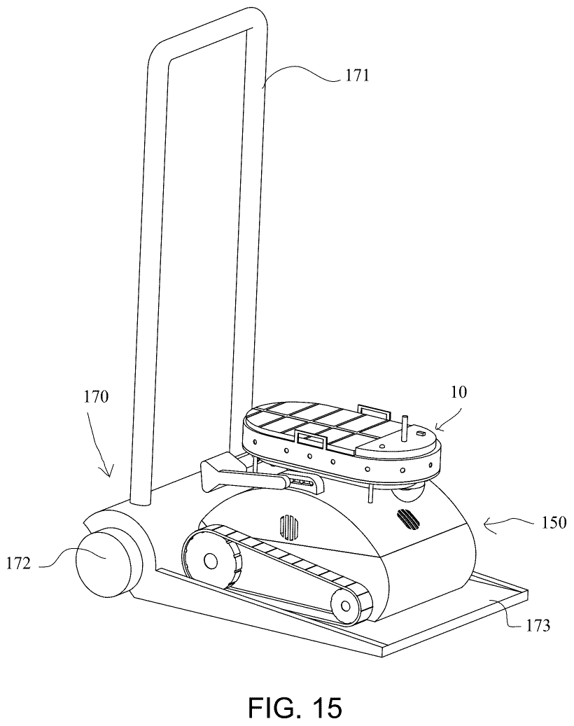

FIGS. 1-6 illustrates examples of floating units 10 and 10′. FIG. 8 illustrates an example of floating unit 10″ and its environment, FIGS. 9-11 illustrates example of a floating unit 10″. FIGS. 12-14 illustrate examples of floating units 10″ and its environment. FIG. 15 illustrates an example of floating unit 10 and its environment.

Any of the floating units may include at least some out of floating unit housing 12, floating unit sidewalls 13, floating unit connector 14, fin 15, legs 16, floating unit handle 17, ultrasonic transducers 18 or 18′, antenna 19 or 19′, solar panel 20, parts 21-25 of foldable solar panel, camera cover 31, camera 32, camera manipulator 33 (for moving the camera), floating unit front cover 34, floating unit bottom 35, floating unit controller 36, motor 37, and at least one floating unit battery 38.

The floating unit housing may be waterproof and may be an insulated polymer-air multi layered hull or housing that may include a hull, a floating unit front cover, floating unit sidewalls that may be partly submerged, and a floating unit bottom that is submerged; construction may be linear or rounded and made of a sturdy construction to protect against transportation impacts. The floating unit may be of any shape: for example: round shape, oval, square or rectangular.

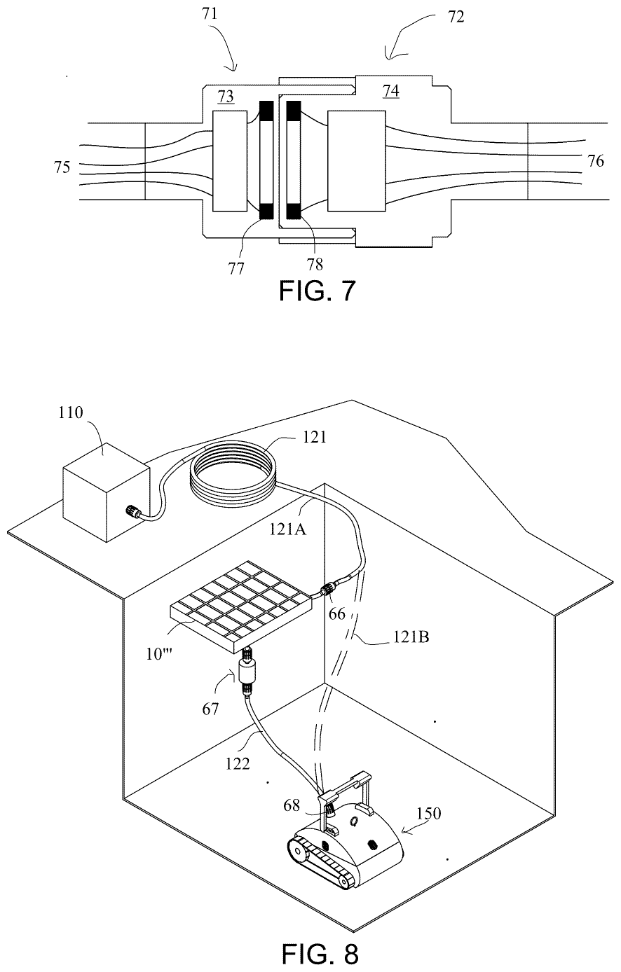

The floating unit and the PCR may be electrically coupled using an electrical cable wiring and waterproof connectors that may tether the floating unit to the PCR from a sealed cable connection at the bottom of the floating unit or on any of the sides of the floating unit. See, for example, floating unit connector 14 of FIG. 1-2. A cross sectional view of wireless charging connectors 71 and 72 is illustrated in FIG. 7. The wireless charging connectors 71 and 72 are connected to each other and include wireless charging connector housings 73 and 74 respectively, and wireless charging coils 77 and 78 respectively that may face each other and convey power received from cables 75 and 76 respectively. The wireless charging coils may be replaced by other wireless charging interfaces. Alternatively, the wireless charging interfaces may be regarded as the wireless charging connectors.

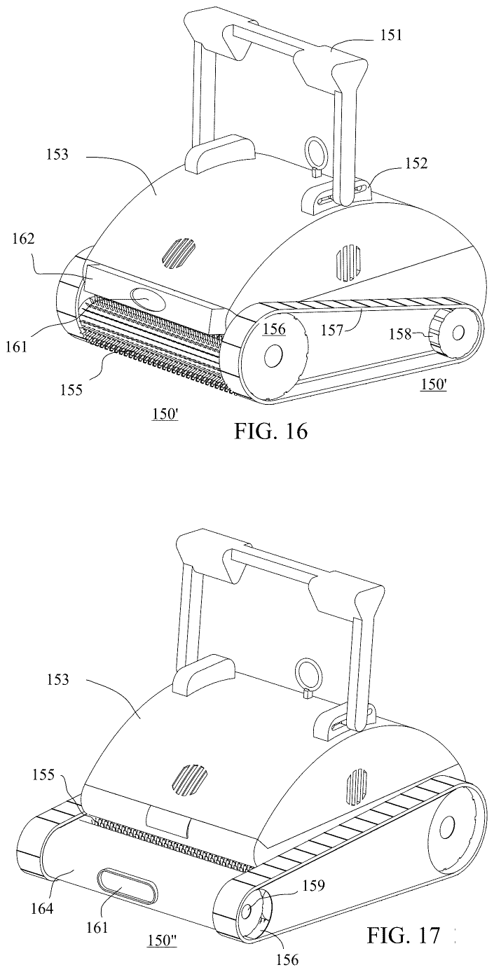

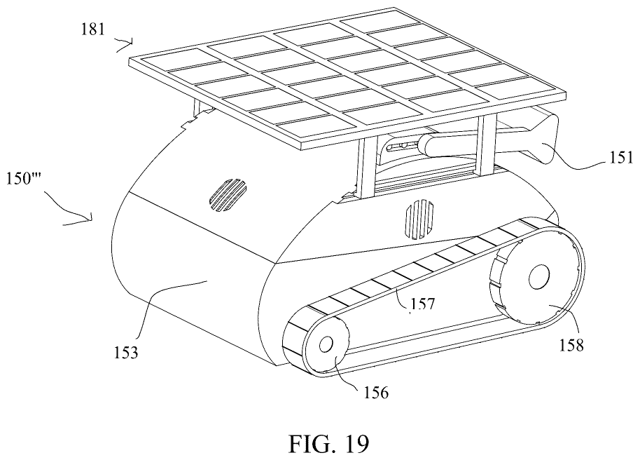

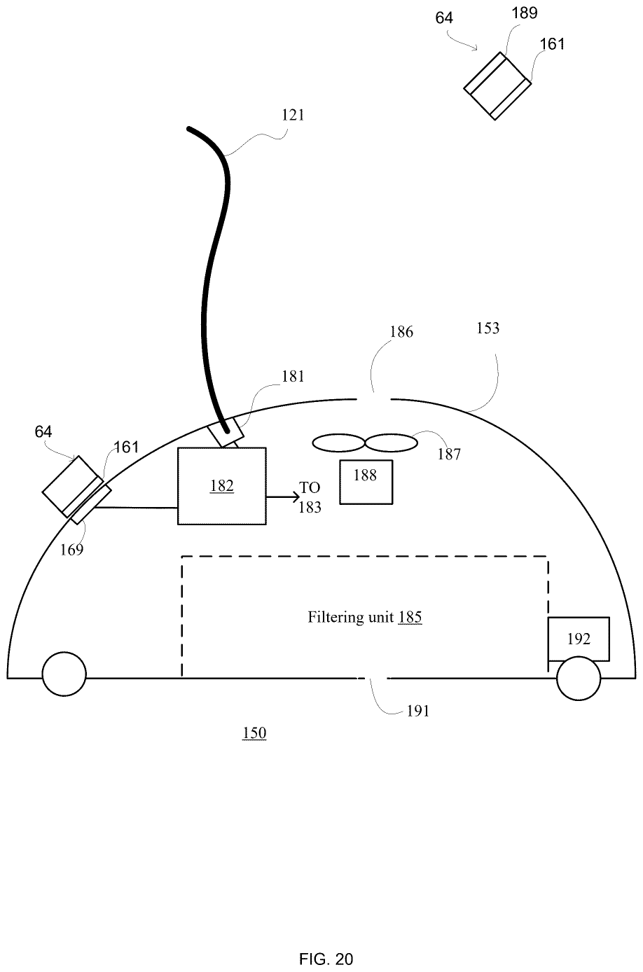

FIGS. 8, 12, 13, 14, 15, 18 and 20 illustrate examples of PCR 150 and its environment. FIGS. 16, 17 and 19 illustrate example of PCR 150′, 150″ and 150′″. FIG. 20 is an example of a part of PCR 150. Any of the PCRs may include at least some out of PCR handle 151, PCR handle interface 152 that interfaces with the PCR handle and allows a rotation or relative movement of the PCR handle in relation to PCR housing 153, brushing wheel 155, front wheel 156, track 157, rear wheel 158, front axis 159 that may pass through rechargeable battery 164, power supply cable interface 161, power supply control unit 182, and power consuming elements 183, a hydraulic path with at least one water suction inlet and at least one water outlet, at least one filtering element located within the hydraulic path to trap water impurities, a waterproof motor unit (may be a power consuming element) that may include at least one pump motor and its impeller to draw water in the hydraulic path, at least one drive motor (may be a power consuming element) to propel the PCR using one or more wheels (for example front wheel and real wheel and/or one or more tracks), rotating brushes (such as brushing wheel 155) to clean pool surfaces, sensors (may be a power consuming element) and a waterproofed central control unit that houses a control PCB and motors. The central control unit may be or may include the power supply control unit 182.

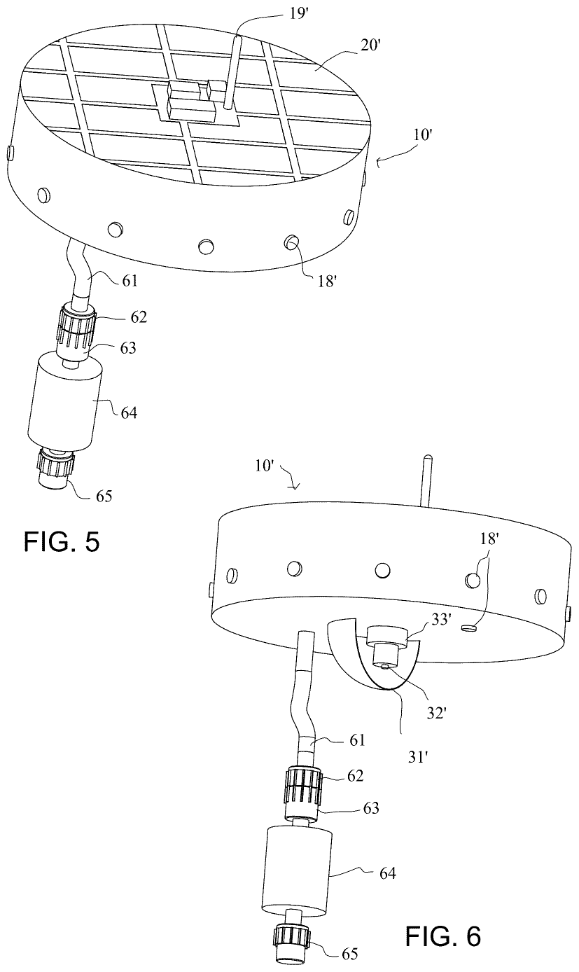

FIGS. 5, 6, 7, 8, 9, 10, 11, 12, 13, 14, 18 illustrate various example of power supply elements such as at least one out of power supply cables 61, 121, 122, one or more wireless charging connectors (62, 63, 65, 71 and 72), a combination (67) of chargeable battery and wireless charging connectors rechargeable battery, a combination (66, 68) of wireless charging connectors, and the like. The connectors are waterproof and enable wireless provision of power.

The floating unit may include a solar panel with photovoltaic cells that may include manually operated or motorized collapsible (or folding) sections (see solar panel parts 21-25 of FIGS. 9-11) to increase solar panel surface area and effectiveness (that may be constructed to include two-sided solar panels to be able to capture light or sunlight both from above or side angles (sun or sky side) and/or reflections from below (pool water surface sides).

The folding and unfolding of the said solar sections may be automatically initiated and controlled by the floating unit controls that may measure the sunlight or light radiation power using an ambient light sensor. As soon as the said radiation starts to decrease, the solar panel may need increased sunlight or light radiation and may thereby command the onboard floating unit motor to set in motion a rotational opening (or folding) of additional (or fewer) solar panel sections.

The floating unit may include at least one rechargeable battery assembly within a waterproofed encasing, on-board the float, that may be removeable; whereby the batteries may each include a PCB that collects and transmits battery status data using a channel between the battery assembly and the PCR control PCB.

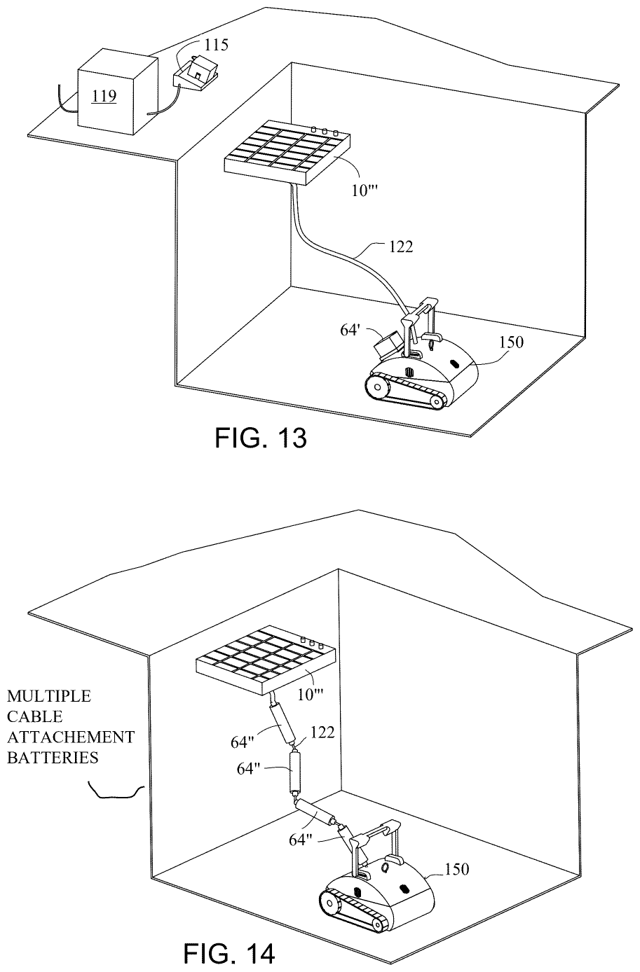

The PCR and/or the floating unit may be charged by an external power supply. Examples of an external power supply are provided in FIG. 8 (external power supply 110), FIG. 12 (external power supply 111), and FIG. 13 (external power supply 119).

External power supply 111 is illustrated as including external power supply control knob 112, external power supply antenna 113, external power supply display 114, rechargeable battery charger 115, external power supply control unit 116. The external power supply control knob 112, external power supply display 114 are examples of a man machine interface. The antenna may be used for wireless communication between a communication unit of the external power supply 111 and other devices (even the PCR). The external power supply control unit 116 may control the provision of power—and may automatically sense whether the power from the external power supply 111 are used for charging batteries or for supplying power to the PCR or the floating unit.

The battery connections may include of inductive primary and secondary coils that contact primary and secondary inductive contacts at both ends of the battery or batteries (A Tx and an Rx). Thereby providing safe underwater electricity transfer. These inductive power contacts or charging contacts may also be used when charging the battery externally, using a power supply charger and a charger cradle.

Data transmitted from the battery may include data such as a battery-voltage regulator, -fullness, -temperature, -error readings, data regarding a protection circuit module (PCM) and status of every internal battery cell; whereby said data may be transmitted (either over an electrical cable that may include 2, 3 or 4 wiring and wireless or an inductive interface (connecting plug or socket) to an end user and/or to the main waterproofed PCR processor and memory PCB control that is located in the hollow body of the PCR.

The system may include a handheld remote-control receiver and transmitter that includes an antenna and a PCB in communication with the PCR, an end-user or both.

The floating unit may include an on-board floating unit electronic PCB control card for controlling the charging of the battery operation.

A console located on the top section of the floating unit housing may include an On-Off float/PCR switch.

The floating unit may include at least one status indication LED that may be flashing in varied colors.

A plug and socket system in the floating unit housing may include a bypass electrical wiring cable that is removably tethered to an external, mains connected, IP67 rated power supply that may be used to override at least one of these: (a) the solar panel electrical battery charging function (b) for indirect PCR powering by charging the PCR battery; for example: a modular bypass of the solar panel at nighttime (c) the floating unit and its solar panel entirely by connecting the bypass cable directly to power the PCR. For example: a modular wiring bypass if the PCR is to be tethered directly to the external power supply when a battery or batteries or the floating unit itself in its entirety, need to be removed for charging externally or to be altogether stored or replaced. It should be noted that in such a case, the cable connections may also be modularly replaced from an induction power transfer to a metal pins power transfer connection to provide to the higher voltages or amperage. Any of the said components may be supplied to end users in kit form.

The override charging may include a tethered electrical cable between an external to the pool AC/DC, mains connected, power supply and plug/socket on the float.

The external power supply/charger may contain a power supply control unit that includes a PCB hardware and software electronic control system; the power supply control unit is connected to a wireless charging interface (plug or socket); wherein the power supply control unit is configured to control (a) a provision of power from the power supply cable to the wireless charging interface; and (b) a provision of power from the wireless charging interface to one or more power consuming elements of the pool cleaning robot.

The power supply control unit may be configured to contain a dual function activation (see FIG. 12). Namely, by a manual switch selector (such as external power supply control knob) activation the output power may, on the one hand, be suitable for a “PCR power” mode by providing for example: ˜120 W-˜180 W electrical power from a mains supply of 115 VAC/240 VAC input converted to up to ˜30 VDC/˜6-8 A output; On the other hand, switch over to a “battery charging” mode to provide electrical output power converted to the required output to charge a battery being charged externally or when charging at least one or multiple submerged underwater batteries (or battery pack or packs that are equivalent terminologies or definitions of “battery” or “batteries”).

As will be discussed below, a battery recognition safety mechanism (may be controlled by the external power supply control unit) may prevent trying to charge a battery with voltage supply of say, 30 VDC, by automatically shutting-off power supply until the user moves the selector switch to “battery charging” position.

The power supply cable interface for interfacing with a power supply cable may have at least a majority of the power supply cable external to the housing;

The space allocated within a PCR housing may be restricted but the need for power is ever increasing. This is true for larger PCR, in larger or deeper pools or both where a longer power cable may be needed, where longer cycle times are needed or, when PCR needs to thoroughly spend time cleaning vertical walls and waterline consuming larger quantities of power. The system may therefore include multiple detachable batteries.

FIG. 14 depicts an example of multiple rechargeable batteries 64″ that are wirelessly charged by the power supply cable 122. The multiple rechargeable batteries 64″ may be attached to the power supply cable by any manner-magnetic, mechanical, and the like. For example—the multiple rechargeable batteries 64″ may be held by cable battery enclosures that are connected to the power supply cable. The rechargeable batteries (once charged) may be coupled to a PCR. Having additional batteries on hand allows the pool owner the flexibility to have one or more batteries in-external charging while one or more batteries are attached to the cable and in-use.

When adding multiple batteries modularly, each battery may require a floatation device that may be incorporated in the battery cable enclosure (such as cable battery enclosure 81 of FIG. 12) to keep the solar panel and/or the batteries themselves afloat.

An end user may manually unscrew and detach the cable connections to remove or replace the battery, to release (or connect) the floating unit or to connect a cable onto an external power supply. This is a quick, electrically safe release/connect system that may be used even while the floating unit or battery is submerged in the water.

The said batteries may be differentiated into different capacities. For example: differentiation based on charging outputs (W/h) that at the lower level may be for example, a minimum of 90 W/h up to 200 W/h.

The modularity of charging outputs, and as will be seen, battery types, provide various charging assemblies and battery models to choose from at varying capacities, speed of charging and costs.

Under the assumptions that the power supply output is set at 200 W, to charge the range of batteries (or packs) may provide a range of outputs to power each battery according to its capacity, for example: ˜21 VDC/˜7 A, 10 A and the like.

Another version power supply/charger of for example: ˜21 VDC/90 W/h power may output 3 A, 1.5 A and the like.

Larger power supply/chargers are envisaged to reach 300 to even 500 W or more depending on battery sizes and PCR sizes (for example Olympic pool size PCR).

The selections for the charging function may also be further dependent on the speed of required charging. Lower outputs and loads may provide slower charging periods. Higher outputs with higher loads may provide faster charging times.

The power supply selector may be further configured to an automatic battery capacity recognition function (FIG. 12). In other words, it may be provided to automatically recognize a battery and the output voltage necessary for the specific battery pack in-charge.

There is provided an additional “fast-charging” button function in the external power supply/charger unit, but an end user will be made aware that faster charging may mean higher battery charging temperatures with shorter battery longevity.

The voltage inputs, outputs and loads policies apply when the electrical power charges a battery (or pack) directly from the solar panel. Whether the battery is included on board the float, attached onto a tethered cable or attached onto the PCR housing or being charged externally in a charging cradle or station that may charge multiple batteries or packs.

An indicator window on the power supply/charger may show information relating to the charging process and the components involved, their power level status, number of charging cycles, battery temperature and so on.

The information may also be uploaded to the cloud and stored for the end user for future reference.

The tethered power supply cable seen in FIGS. 8, 12 may be provided at a variety of lengths and in separate kit forms. For example: one meter long for near pool wall override or up to 50 meters long in the event of PCR operating in a large public or Olympic sized pool.

The plugs and sockets described herein, may include low voltage, inductive type fittings or water/rust resistant electrical pins but as stated above, alternative, non-inductive cable connections may be supplied separately, or an entire spare cable may be installed.

The floating unit may include at least one directional fin or rudder (6) attached to the submerged section of the floating unit hull and/or its submerged sides. The fin or rudder may be moveable and motorized for controlled in-tandem navigation with the PCR.

A compass and/or a gyro compass and/or an accelerometer on board the floating unit or the PCR may transmit navigational data to the PCR control to direct the PCR along a cleaning trajectory.

The floating unit and/or the PCR may include a laser rangefinder for pool environment distance measuring; and/or an obstacle proximity recognition sensor; and/or a camera that is attached to the submerged bottom hull of the floating unit and facing the downward towards the underwater environment including the pool cleaning robot; and/or lighting means to assist the camera with nighttime photography; and/or an electronic PCB control card that stores and processes navigational data.

The navigation floating platform may be configured to assist with the navigation of the PCR and that may be constructed of the insulated polymer-air multi layered water sealed floating hull or housing.

The floating unit may include the said solar panel and an electrical cable wiring with waterproofed connectors that may be tethered to the PCR;

The floating unit may include mor than one fin or rudder.

The floating unit may include a downward facing camera that is attached to the bottom hull. A Gyrocompass may provide directional bearings or azimuths.

The floating unit may be electrically powered by either a tethered cable connected to an external power supply or, from at least one on-board the PCR rechargeable batteries using its own power input from external, cable wired power supply.

The navigation floating platform (Float) may be proportionally of a smaller dimension than what is depicted. As can be seen in FIGS. 5, 6 it may be configured to perform waterline surface navigation on behalf of the tethered PCR by means of an on-board navigation system.

The said navigation floating unit may exclude a solar panel, battery or any battery charging functionality. It may serve solely for navigation and communications. A side use of such a floating unit is that it may also serve to grab the floating unit in order to pull the floating unit and the entire PCR out of the water at the end of a cleaning cycle.

The said navigation floating unit platform may nevertheless include on-board pool navigational and mapping sensors for the navigation of the PCR by communicating corrective navigational trajectories to the PCR.

Tasks include pool mapping and distance measuring to pool obstacles, features or constituents in the pool that may, for example, be a wall, ladder, skimmer or stairs by employing a sensor system may include of at least one ultrasonic transducer but that may include 2, 3, 4 and ideally up to 16 such side facing ultrasonic sensors that may be pointing at 16 different circular compass angles of its surroundings. For larger pools, for example: Olympic size pools, more transducers are required to acquire a higher pool map resolution in a shorter period of time.

The ultrasonic transducer are distance sensors for measuring the distance of the floating unit and the PCR from the wall surface. These ultrasonic sensors emit sound (ultrasonic waves) that measure the distance to an object by the time it takes for the sound wave emitted from the floating unit to be reflected and received back by the float. The ultrasonic distance transducers may detect obstacles such as walls, ladders located on the wall surface of the pool.

Pool dimension parameters may be fed into the PCB memory by means of remote device.

The sequencing of the transducers may start with an electrical triggering vibration that will cause a forward moving ultrasonic wave in the water until it meets a rigid pool structure or any other element in the pool and echoes back a return signal to the transmitting transducer. The response speed of each transducer signal is recognizable and discerned by its own return signal without confounding it with other signals that may have been sent before.

For example, in a 15 meters long pool, the ultrasonic signal may travel the approximate distance of 15 meters surface at 0.01 seconds to meet a rigid obstacle, a structure or constituent. The return signal from an impacted object or structure will also travel the return 15 meters at 0.01 seconds, to make for a total of 0.02 seconds cycle per single ultra-sonic transducer. This is under the assumption the sound travels 1480 m/s but that may vary about +−5% depending on water chemistry (turbidity, dirt, salinity) and temperature. A 30 meters pool distance pulse and return cycle may take double that time.

The return reading registers the speed/time of the return signal received and so it may measure and record a distance.

The return reading registers the return signal may further plot a first point on a virtual map of the pool stored in the main PCB of the floating unit or the PCB in the PCR or in both. Namely, it may have recognized a wall, an obstacle or a constituent and it now it has acquired the distance and its compass direction or bearing.

A compass or gyrocompass may be included in the float.

If a return signal is not received back at the sending transducer, it may mean that the PCR is located not in a 15 meters long pool but rather in say, a 50 meters pool and will therefore need to resend pulses more often, by trial and error, to receive a return signal. If no signal is received at all, this may mean that it is a beach-entry type pool or that the transducer is not fully immersed in water.

The return signal may also be strong and fast or weak and slow or, as stated above, not present at all. A strong and fast return signal will mean nearness to an obstacle a pool constituent such as being in front of pool wall. A weak or slow signal may mean because of a difficult angled obstacle that is not perpendicular to the sent signal.

Recognizing return signals bouncing off pool stairs may return numerous signals where each staircase may return signal at different times and distance. The distance differences each would be anything between 10-20 centimeters so from that it may be deducted that the pool constituent is a flight of stairs.

After the first pulse cycle, a MUX switching component (hybrid multiplexer that may be silicone based) chooses the next or the second ultra-sonic transducer to be triggered.

There is provided a sequence order in these triggering. For example, for a configuration that may include 4 side outward facing transducers, the first pulse may start with the front side ultrasonic, pulsing a sonic beam and immediately after receiving the response, trigger a port or starboard side transducer positioned at 90 degrees. Following that, it then triggers the transducer in the aft at 180 degrees, and last one on the starboard or port side at 90 degrees. This circular triggering procedure may accumulate sufficient data to map the perimeters and identify the important constituents of the pool.

The next pulse triggering may be activated for corrections or confirmations or for fine tuning other obstructions (see below) that may be of importance to be communicated to the PCR that may record the inputs to form a cumulative pool map in its on-board memory.

The platform may include a camera that may be an additional or a standalone element in this embodiment. A lighting source that may be attached to the submerged bottom surface of the floating unit and arranged to photograph the bottom of the pool, including the PCR and its tethered cable in daylight and in darkness.

The downward facing camera towards the bottom of the pool may be used as a pool depth measurement device or to view the PCR while cleaning the pool, its location, its trajectory, bearing, speed of movement, capturing of pool slopes, stairs, lights, VGB, return jets, skimmer, spotlights, dirt locations and the like.

In darkness or when water turbidity are at a level where camera vision is impractical or impossible-even with an additional lighting device—the depth of the pool could be measured by tracking the straightness or slackness of the tethered cable (floating unit to PCR). In shallower waters (˜1.2 meters deep) the ˜4-meter-long tethering cable may be loose or slack. In deeper waters (˜2-4 meters deep) the cable may lose its slackness and straighten-up. This event can be viewed optically and interpreted by the PCR main PCB control.

An additional or alternative to the camera, a downward facing ultra-sonic transducer may be used as a pool depth measurement device.

The navigation system platform is controlled by an on-board floating unit microcontroller unit (MCU)

The operation of the floating unit navigation system starts with the MCU triggering a transducer pulse. The example of 4 ultrasonic transducers operation will trigger each transducer one after the other in a separate triggering sequence.

The triggered transducer creates a sonic pulse of 120-1000 Khz in the water awaiting a response of a received pulse from an obstacle or a pool constituent.

After the mapping of the pool and tracking of the PCR are achieved, the floating unit may instruct the PCR how to move on the submerged surfaces. The data between the floating unit and the PCR is transferred using the 3^{rd} or 4^{th} data wirings of the tethered cable.

The floating unit may include of a wireless module to send data to the cloud via the internet (like Lora/GSM/WIFI/Low Radio frequencies below 1000 MHz). The floating unit wireless module can help the floating unit the with figuring out its location by measuring its signal strength. The floating unit may contain a GPS in its top edge to help it with mapping the pool.

Concepts and combinations of features of the invention in this specification may include elements specified in any alternative embodiment and may be wholly or partly included—or interchangeably used—in part or in full—in any other embodiment in this specification.

There may be provided a system in which a water sealed floating housing may include a housing, a float, a PCR, a cable, and a battery or batteries that may be enclosed in a waterproof and impact resistant encasing.

The system may include an insulated polymer-air multi layered hull or housing may include a hull, a cover, side sections that may be partly submerged, and a bottom section that is submerged; construction may be linear or rounded and made of a sturdy construction to protect from transportation impacts.

The system may include an electrical cable wiring and waterproofed connectors that may tether the floating unit to the PCR from a sealed cable connection at the bottom of the float.

The floating unit may include a solar panel with photovoltaic cells that may me be configured to be manually or be motorically deployed or folded (open or collapsed) sections to increase solar panel surface area and effectiveness that will be discussed further-on in this specification.

At least one battery that may be rechargeable battery or batteries assemblies that may be attached and connected to the electrical cable that is tethering the floating unit with the PCR.

The battery or batteries depicted in any of the figures may be removeable or replaceable in the sense that the battery, or any additional battery that may be modularly attached to the cable, may be connected to the cable by means of waterproofed electrical cable connections that may transfer electrical power and/or data inductively.

Each such said battery module may include of a PCB that collects and transmits battery status data using a channel between the battery assembly and the main control PCB function inside the PCR.

Each said battery modules may be easily connected to or disconnected from the tethered said cable using the.

The system may be provided in which an end user may choose to manually remove or to replace only the battery out from the battery cable enclosure and keep the enclosure or enclosures attached onto the cable. This enclosure may remain attached permanently or temporarily.

The battery enclosure system may include a battery housing that may be removably attached onto the tethered cable.

A battery inserted into and held by a cable battery enclosure that is attached and removably connected to the tethered electrical cable by means of the waterproofed cable connections that may transfer electrical power and/or data inductively to charge the battery which in turn powers the PCR. An end user may unscrew the cable connections to remove or replace the enclosure or add multiple enclosures.

The enclosure is constructed from a polymeric compound, built sturdily to protect from impacts.

The battery connections inside of the enclosure may include of inductive primary and secondary coils that contact primary and secondary inductive contacts at both ends of the battery or batteries. Thereby providing safe underwater electricity transfer.

A removed battery or batteries in this entire specification may be placed in a charging cradle to be charged externally to the pool by a mains connected power supply that may also provide as a charger while at least one battery keeps on powering the PCR.

There may be provided a system in which at least one battery, hereinafter defined as a battery module or module, may be attached directly onto the housing of the PCR.

While attached and connected to the housing, the battery or batteries (“module”) transfer electrical power inductively to power the PCR motor or motors, PCB control function, sensors and the like.

The module may be charged by the floating unit or any of the said floats that may include a floating solar panel that converts and delivers the electrically converted solar power inductively to the said battery module through the PCR.

Meaning, in FIG. 20 the battery power supply cable is attached and connected to the PCR housing, whereby the electrical power is transferred onto a charging interface, such as, an inductive power transfer mechanism (a TX 169 onto an RX 161) that is located inside the PCR housing (not shown).

The battery module may be detachable and removably (magnetically, electrostatically or by any other holding means) attached onto the body. Namely, when a battery or a module was detached or removed from the PCR and connected to an external charging unit (a caddy 170 in FIG. 12), the PCR may continue working by being powered by a replacement battery module (115 in FIG. 12). The charging unit-like the battery-contains matching inductive electrical contacts.

The battery module transfers low voltage electrical inductive power to power the PCR motors and PCB control unit and sensors, and also collects and transmits the battery status data using a channel (or dedicated electrical wiring) between the battery module and the PCR control PCB; the data transmitted may include data on such as battery-voltage regulator, -fullness, -temperature, -error readings, a protection circuit module (PCM) and status of every battery cell that may include the module.

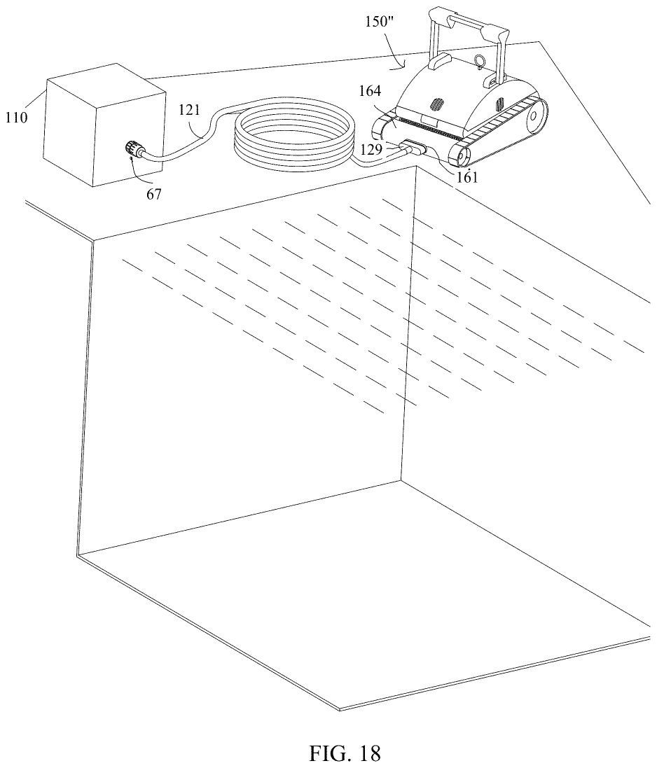

The said battery or batteries (battery) may be attached onto any of the PCR housing or body or its attached sub-assemblies (see for example FIGS. 16 and 17). The battery may be configured to be attached onto the body whereby a battery cover facia or shroud encloses the entire battery making it invisible to the user. The battery is electrically wired onto the control PCB and motors that are located in a sealed motor unit inside the housing. The battery may be charged by means of a removeable and detachable power supply cable that is either magnetically or mechanically attached onto the said polymeric cover facia or shroud of the said covering shroud. The power supply cable may be manually connected—on its one end—to an external to the pool electrical power supply or charger that is connected to a mains electrical outlet (FIG. 18). The charging process is wirelessly inductive whereby the said power supply cable contains a power supply cable wireless charging interface 129 at its other end. The power supply cable wireless charging interface 129 is placed near or close to the battery: either by direct magnetic or mechanical attachment or by attaching the said power supply cable wireless charging interface 129 to a rechargeable battery wireless charging interface 161 or another specific charging location on the said cover or fascia of the said covering shroud. The inductive power transfer may then be performed from the power supply cable wireless charging interface 129 through the polymeric wall or barrier of the said cover and onto the rechargeable battery wireless charging interface 161 that is attached onto, or in the vicinity, of the said battery.

After a cleaning cycle ended and the pool owner chooses to remove the PCR from the pool, the PCR may be placed on a caddy or a trolley to carry and to store the PCR, its power supply (not shown) and the floating charger or float. FIG. 15 illustrates an example of caddy 170 having a caddy handle 171, caddy wheels 172 and caddy base 171. A PCR and a floating unit are supported by the caddy base 173.

The floating unit of any type described in this specification may include protruding members or legs located and attached onto any of the floats described and may be located at the bottom floating unit surface or sides.

These members serve to position the floating unit onto the caddy or onto the PCR while positioned on the caddy. This is to avoid slipping or damaging the caddy or PCR surfaces whilst in movement.

The members may be cylindrical, round or square with a rubber compound attached to the tip of each member.

Each member may also fit and be aligned into pre-molded depressions or indentations formed on the plastic surfaces of either the PCR top/lid section or the caddy.

Another arrangement for the removal for storage of the PCR from the pool involves placing the PCR, its power supply (not shown) and the floating charger or floating unit on the said caddy or a trolley. The floating charger or floating unit contains at least two narrow, substantially L-shaped sturdy bottom protrusions (for example, at least one fin on each floating unit side), that are slid onto two matching lateral longitudinal grooves located on the external side of the housing. The said fins may be released by pulling the floating unit backwards (or forwards), by sliding the fins out of the said grooves.

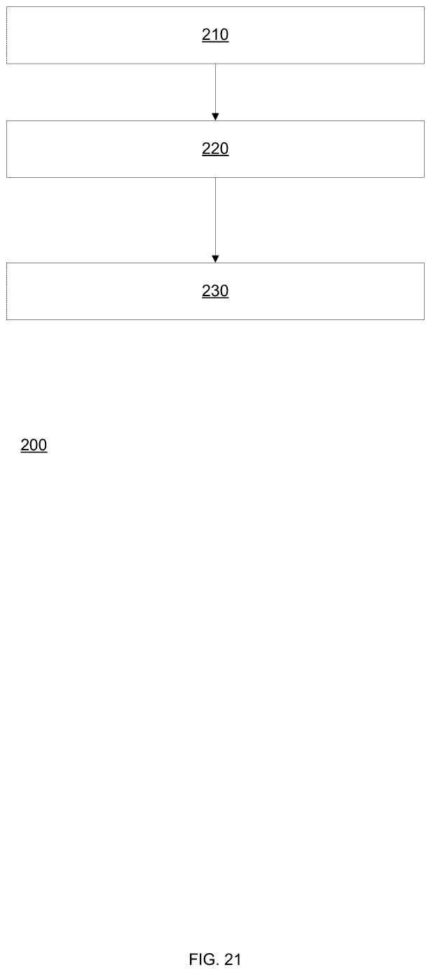

FIG. 21 illustrates an example of method 200 for power control.

Method 200 may include step 210 of feeding a power supply cable with power.

Step 210 may include at least one out of feeding the power supply cable by power from a floating unit, feeding the power supply cable by power from an external power supply, feeding the power supply cable by power from a floating unit that is equipped with a solar panel, or feeding the power supply cable by power from a foldable solar panel.

Step 210 may be followed by step 220 of receiving power (a) by a power supply cable interface of a pool cleaning, and (b) from a power supply cable that has at least a part that is external to a housing of the pool cleaning robot.

Step 220 may be followed by step 230 of controlling, by a power supply control unit of the pool cleaning robot, (a) a provision of power from the power supply cable to a wireless charging interface of the pool cleaning robot; and (b) a provision of power from the wireless charging interface to one or more power consuming elements of the pool cleaning robot.

Step 230 may include supplying the power.

When the wireless charging interface is wirelessly coupled to a rechargeable battery then step 230 may include controlling the provision of power to the rechargeable battery and the reception of power from the rechargeable battery.

Step 230 may include charging, by the wireless charging interface, a rechargeable battery via a battery wireless charging interface, when receiving the power from the power supply cable.

Step 230 may include providing power, by the wireless charging interface, from the rechargeable battery; and controlling, by the power supply control unit, a provision of the power from the detachable rechargeable battery to one or more power consuming elements of the pool cleaning robot.

Step 230 may include determining whether between option (a) and option (b). The determining may be made in any manner—for example—selecting option (a) when the PCR is not scheduled to clean the pool, selecting option (a) when a rechargeable battery that is wirelessly charged by the wireless charging interface is not full enough, selecting option (b) when the PCR is scheduled to clean the pool and the rechargeable battery is full enough.

Method 200 may also include step 240 or charging a rechargeable battery in another manner.

Step 240 may include at least one of the following: (i) charging the battery, by an entity that is external to the pool cleaning robot, via an additional battery wireless charging interface, wherein the additional battery wireless charging interface may be facing away from the pool cleaning robot, (ii) charging a rechargeable battery by an external power supply unit, (iii) charging a detachable rechargeable battery, by the power supply cable, while the detachable rechargeable battery is located within a battery enclosure that is configured to detachably hold the detachable rechargeable battery to the power supply cable, and the like.

The rechargeable battery may be a detachable rechargeable battery or a non-detachable battery.

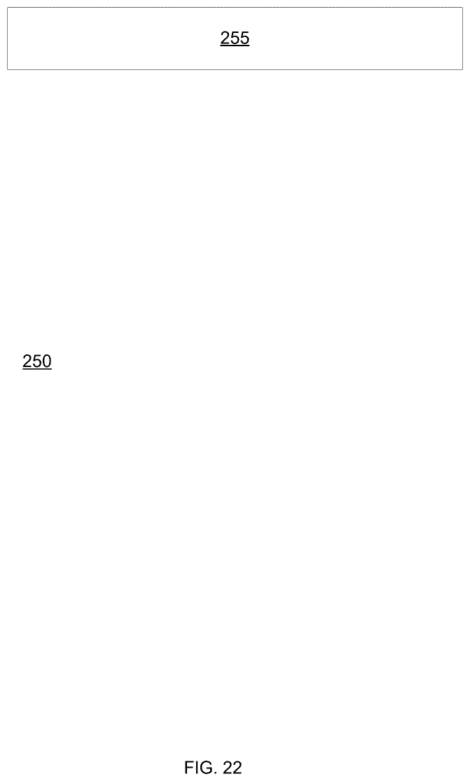

FIG. 22 illustrates an example of method 250 for wirelessly providing power to a pool cleaning robot.

Method 250 may include step 255 of wirelessly receiving power, by a wireless charging interface of the pool cleaning robot, via a power supply cable and from a floating unit that may include a solar panel. The pool cleaning robot may include detachable rechargeable battery.

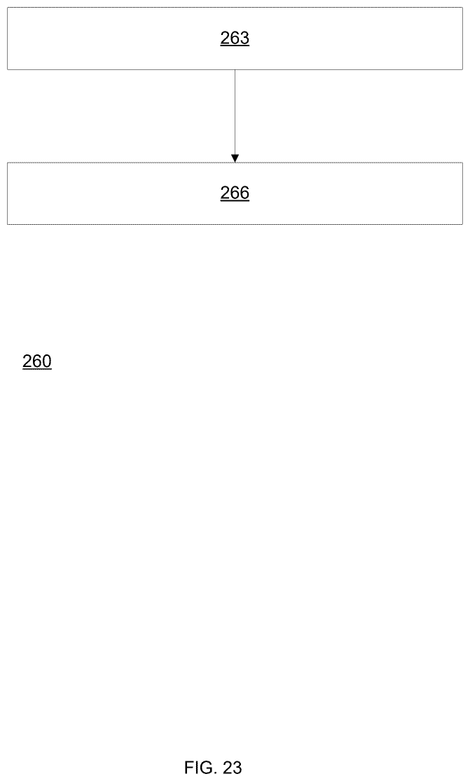

FIG. 23 illustrates an example of method 260 for wirelessly providing power to a pool cleaning robot.

Method 260 may include step 263 of selecting a power supplier out of a floating unit and an external power supply unit, to provide a selected power supplier. The selection can be made in any manner (for example based on a capability of the power suppliers to provide power—for example preferring the floating unit when the floating unit can supply solar based power).

Step 263 may be followed by step 266 of wirelessly providing the power to the pool cleaning robot from the selected power supplier via one power supply cable of at least one power supply cable.

The at least one power supply cable may include a first power supply cable and a second power supply cable; wherein a first end of the first power supply cable is electrically coupled to the external power supply unit and a first end of the second power supply unit is coupled to the floating unit.

The following reference numbers are used in the figures:

| Reference | |
|---|---|
| number | description |
| 10, 10′, 10″1 | floating unit |
| 12 | floating unit housing |
| 13 | floating unit sidewalls |
| 14 | floating unit connector |
| 15 | fin |
| 16 | legs |
| 17 | floating unit handle |
| 18, 18′ | ultrasonic transducers |
| 19, 19′ | antenna |
| 20, 20′ | solar panel |
| 21-25 | parts of foldable solar panel |
| 31 | camera cover |
| 32 | camera |
| 33 | camera manipulator |
| 34 | floating unit front cover |
| 35 | floating unit bottom |
| 36 | floating unit controller |
| 37 | motor |
| 38 | at least one floating unit battery |
| 61, 121, 122 | power supply cable |
| 62, 63, 65, 71, 72 | wireless charging connectors |
| 64, 64′, 64″ | rechargeable battery |
| 67 | combination of chargeable battery and wireless |
| | charging connectors |
| 66, 68 | combinations of wireless charging connectors |
| 73, 74 | wireless charging connector housings |
| 75, 76 | cables |
| 77, 78 | wireless charging coils |
| 81 | cable battery enclosure |
| 110, 111, 119 | external power supply |
| 112 | external power supply control knob |
| 113 | external power supply antenna |
| 114 | external power supply display |
| 115 | rechargeable battery charger |
| 116 | external power supply control unit |
| 121A, 121B | connectivity options for the power supply cable |
| 129 | Power supply cable wireless charging interface |
| 150, 150′, 150″ | pool cleaning robot (PCR) |
| 151 | PCR handle |
| 152 | PCR handle interface |
| 153 | PCR housing |
| 155 | brushing wheel |
| 156 | front wheel |
| 157 | track |
| 158 | rear wheel |
| 159 | front axis |
| 161 | rechargeable battery wireless charging interface |
| 162, 164 | rechargeable battery |
| 170 | caddy |
| 171 | caddy handle |
| 172 | caddy wheels |
| 173 | caddy base |
| 181 | power supply control unit |
| 182 | power supply cable interface |
| 183 | power consuming elements |

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top.” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

The phrase “may be X” indicates that condition X may be fulfilled. This phrase also suggests that condition X may not be fulfilled. For example—any reference to a pool cleaning robot as including a certain component should also cover the scenario in which the pool cleaning robot does not include the certain component. For example—any reference to a method as including a certain step should also cover the scenario in which the method does not include the certain component. Yet for another exampleany reference to a pool cleaning robot that is configured to perform a certain operation should also cover the scenario in which the pool cleaning robot is not configured to perform the certain operation.

The terms “pool cleaner” and “pool cleaning robot” are used in an autonomous manner and may refer to a self-propelled pool cleaner.

The terms “including”, “comprising”, “having”, “consisting” and “consisting essentially of” are used in an interchangeable manner. For exampleany method may include at least the steps included in the figures and/or in the specification, only the steps included in the figures and/or the specification. The same applies to the pool cleaning robot and the mobile computer.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected.” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one as or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements the mere fact that certain measures are recited in mutually different claims does not indicate that a combination of these measures cannot be used to advantage.

Any system, apparatus or device referred to this patent application includes at least one hardware component.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Any combination of any component of any component and/or unit of pool cleaning robot that is illustrated in any of the figures and/or specification and/or the claims may be provided.

Any combination of any pool cleaning robot illustrated in any of the figures and/or specification and/or the claims may be provided.

Any combination of any set of pool cleaning robots illustrated in any of the figures and/or specification and/or the claims may be provided.

Any combination of steps, operations and/or methods illustrated in any of the figures and/or specification and/or the claims may be provided.

Any combination of operations illustrated in any of the figures and/or specification and/or the claims may be provided.

Any combination of methods illustrated in any of the figures and/or specification and/or the claims may be provided.

Thus, these terms are not necessarily intended to indicate temporal or other prioritization of such elements. The mere fact that certain measures are recited in mutually different claims does not indicate that a combination of these measures cannot be used to advantage.

We claim:

1-41. (canceled)

42. A pool cleaning robot comprising:
one or more power consuming elements:
a power supply unit that is configured to supply power to the one or more power consuming elements interchangeably using, at different points in time, different batteries having different capacities.

43. The pool cleaning robot according to claim 42, wherein the different batteries are detachable batteries.

44. The pool cleaning robot according to claim 42, wherein the different batteries are detachable batteries, and wherein the power supply unit is configured to receive power from the different batteries using one or more wireless charging interfaces.

45. The pool cleaning robot according to claim 42, wherein the different batteries are interchangeably located within a housing of the pool cleaning robot.

46. The pool cleaning robot according to claim 42, wherein the different batteries are coupled to the pool cleaning robot using a cable and one or more charging interfaces.

47. The pool cleaning robot according to claim 42, wherein the different batteries differ from each other by power output, speed of charging and cost.

48. The pool cleaning robot according to claim 42, wherein the different batteries belong to a kit.

49. The pool cleaning robot according to claim 42 wherein the power supply is further configured automatically determine a capacity of a battery coupled to the pool cleaning robot.

50. The pool cleaning robot according to claim 49, that is configured to automatically recognize a battery and an output voltage necessary for charging the battery.

51. A method for power supply of a pool cleaning robot, the method comprises:
supplying power, to one or more power consuming elements of the pool cleaning robot, interchangeably using, at different points in time, different batteries having different capacities.

52. The method according to claim 51, comprising detaching the different batteries from the pool cleaning robot.

53. The method according to claim 51, wherein the different batteries are detachable batteries, and wherein the power supply unit is configured to receive power from the different batteries using one or more charging interfaces.

54. The method according to claim 51, wherein the different batteries are located within a housing of the pool cleaning robot.

55. The method according to claim 51, wherein the different batteries battery are coupled to the pool cleaning robot using a cable and one or more charging interfaces.

56. The method according to claim 51, comprising charging the different batteries while the different batteries are coupled to a power supply cable.

57. The method according to claim 56, wherein the different batteries are coupled to the cable by cable battery enclosures.

58. The method according to claim 51, further comprising replacing one battery of the different batteries by another battery of the different batteries.

59. The method according to claim 51, wherein the different batteries differ from each other by power output, speed of charging and cost.

60. The method according to claim 51 comprising selecting a battery out of a kit that comprises the different batteries.

61. The method according to claim 51 comprising automatically recognizing, by the pool cleaning robot, one or more parameter of a battery that is coupled to the pool cleaning robot.
